(19) United States
(12) Patent Application Publication
(10) Pub. No.: US 2025/0014460 A1
(43) Pub. Date: Jan. 9, 2025

(54) SYSTEMS AND METHODS OF AUTONOMOUS TRANSPORT MAPPING

(71) Applicant: TORC Robotics, Inc., Blacksburg, VA (US)

(72) Inventor: Christopher HARRISON, Blacksburg, VA (US)

(73) Assignee: TORC Robotics, Inc., Blacksburg, VA (US)

(21) Appl. No.: 18/219,611

(22) Filed: Jul. 7, 2023

(51) Int. Cl. G08G 1/01; G08G 1/0967; H04W 4/46

(52) U.S. Cl. CPC G08G 1/0141; G08G 1/096725; G08G 1/096791; H04W 4/46

(57) ABSTRACT

A method of providing information around road based events through autonomous vehicles. The method describes how a system can maintain or upload information around a digital map indicating locations of events detected. The system can react to updated events to affect route planning, biasing and lane selection. The system can transmit updated map information to various road users including other autonomous vehicles.

### TECHNICAL FIELD

The present disclosure relates generally to vehicle control systems and, more specifically, to autonomous transport mapping systems.

### BACKGROUND

The use of autonomous vehicles has become increasingly prevalent in recent years, with the potential for numerous benefits. Autonomous vehicles encounter many of the roadway events faced by human piloted vehicles. For example, events such as road debris, potholes, traffic collisions, or congestion may interfere with autonomous vehicle operation. The interference can result in the autonomous vehicles experiencing or performing evasive actions, delays, detours, or collisions. Further, autonomous vehicles may operate based on data collected substantially locally. For example, an autonomous vehicle can receive data from a field of view of a sensor located on or in the autonomous vehicle and making local decisions (e.g., navigational decisions) based upon the locally received data. Sensors on autonomous vehicles can be a part of the autonomous vehicle's autonomy systems, such as forward or rear facing cameras, radars, lidars and the like. The sensors can be positioned, specified, or otherwise configured to detect events for the local operation.

### SUMMARY

Autonomous vehicles can detect information (e.g., sensor data or other indications of events) which may be relevant to the operation of other vehicles (e.g., other autonomous vehicles or road users). A system (e.g., a server) in network communication with various vehicles can receive the sensor data or indications of events from the vehicles to maintain (e.g., store, add, remove, modify, annotate, and the like) the events on a digital map. The system can include or interface with a set of vehicles such that operation of various autonomous vehicles of the set can depend on an indication of an event or sensor data from another of the set of vehicles. For example, the system can update and transmit the digital map to different autonomous vehicles over time. The autonomous vehicles can receive the digital map and perform navigational actions (e.g., route selection, lane selection, etc.) based on information in the digital map.

The set of vehicles in network communication with the system can each include different types of sensors and/or sensors at different locations on the respective vehicles to collect data related to events. The vehicles can transmit the collected data to the server. The server can identify the events and/or determine the types of events based on the collected data. In some cases, the individual vehicles can use local processing to identify the events and/or types of the events based on the data collected from the sensors. In some cases, the individual vehicles can use local processing to identify the events and/or types of the events based on the data collected from the sensors. The system (e.g., the server) can receive indications of events from any of the set of vehicles and provide a digital map including an indication of the events (e.g., obstacles, crashes, temporary road signs, temporary road conditions (e.g., ice on the surface of the road), etc.) to the set of vehicles. Certain data may be ingested by a vehicle autonomy system or other processors of the system based on the sensor types, placement, indication, or so forth. For example, an object location at a certain position within a field of view may be located in a lane based on a predefined directionality associated with the detecting sensor. The system can provide certain map data selectively, such as based on a location, heading, route, or other information associated with a vehicle, which may reduce network congestion, edge processing, or so forth.

The indication or sensor data can include an indication of an existence of an event, and may contain further event information. For example, the indication of the event can include an event location, an event summary, an event type, a relevant portion of a roadway, a distance from a centerline or other portion of the roadway, a dimension, a reflectivity, a rate of speed, an object detection, or so forth. In some embodiments, the system can update event disposition over time for the map. For example, by receiving iterative updates from one or more autonomous vehicles, the system can track a change in position associated with an event (e.g., vehicles involved in a collision transported to the side of the road, migration of road debris within or between lanes, or so forth).

Although frequently referred to, herein, with regard to autonomous vehicles, in some embodiments, the systems and methods described herein can be employed with human piloted vehicles. Such embodiments may reduce task loading of vehicle operators, or provide sensor data which exceeds the practical limits of data entry of a human operator. Moreover, such techniques can detect information which is not sensed by a human operator (e.g., non-visible spectrum imaging such as LiDAR in heavy fog, rear facing cameras, thermal data, or so forth).

According to the systems and methods disclosed herein, a system such as a server which is remote from, distributed across, or otherwise interfacing with various autonomous vehicles can maintain a digital map including an indication of events detected by the autonomous vehicles or upload data to other digital maps. The system can receive messages including indications of the events, such as an event type, event location, event size, or sensor data associated with the event (e.g., images such as LiDAR or radar images, visible spectrum images such as images of an object or event from a raw camera or a perception stack, or so forth). In some embodiments, the system can determine the events based on the received indication (e.g., based on received sensor data). The messages can be automatically generated by the autonomous vehicle. The messages can follow a predefined format, or be received according to predefined sensor positions, fields of view, data structures, or otherwise configured for receipt by the server or other autonomous vehicles. For example, the various autonomous vehicles can maintain instances of a common sensor suite, and provide the indication or sensor data based on the sensor suite (e.g., a radar reflectivity or edge detection system of the vehicles may be related such that information determined by one autonomous vehicle can be ingested or compared to sensor data from another autonomous vehicle). The system can insert the indication of the location into a digital map to generate an update thereto, and convey the digital map to one or more autonomous vehicles. For example, the system can convey the digital map, according to a vehicle speed, heading, location, or other data associated therewith, or may convey the digital map to all vehicles in network communication with the system. In some cases, the system can include an amount and/or size of debris in the indications to communicate to authorities and/or a road commission to use to improve safety on the roadways.

An embodiment of the present is directed to a system. The system can include one or more processors. The one or more processors can maintain a digital map indicating locations of events based on a plurality of messages containing indications of the locations of the events. The one or more processors can receive a first automatically generated message of the plurality of messages, from a first autonomous vehicle in response to a detection of an event. The first automatically generated message can include an indication of a location associated with the first autonomous vehicle. The first automatically generated message can include an indication of the event. The one or more processors can insert the indication of the location associated with the first autonomous vehicle and the indication of the event into the digital map to generate an updated digital map. The one or more processors can transmit the updated digital map to a second autonomous vehicle or server.

Another embodiment of the present disclosure is directed to a method. The method may be performed by one or more processors. The method includes maintaining a digital map, indicating locations of events based on a plurality of messages containing indications of the locations of the events. The method includes receiving a first automatically generated message of the plurality of messages, from a first autonomous vehicle in response to a detection of an event. The first automatically generated message can include an indication of a location associated with the first autonomous vehicle. The first automatically generated message can include an indication of the event. The method includes inserting, by the one or more processors, the indication of the location associated with the first autonomous vehicle and the indication of the event into the digital map to generate an updated digital map. The method includes transmitting, by the one or more processors, the updated digital map to a second autonomous vehicle.

### BRIEF DESCRIPTION OF THE DRAWINGS

The accompanying drawings, which are incorporated in and constitute a part of this specification, illustrate various exemplary embodiments and, together with the description, serve to explain the principles of the disclosed embodiments.

FIG. 1 is a bird's-eye view of a roadway including a schematic representation of a vehicle and aspects of an autonomy system of the vehicle, according to an embodiment.

FIG. 2 is a system for detecting events to add to a digital map, according to an embodiment.

FIG. 3 is a block diagram for a data processing system for detecting events to add to a digital map, according to an embodiments.

FIG. 4A is another bird's-eye view of a roadway, including a schematic representation of various vehicles, according to an embodiment.

FIG. 4B is a graphical representation of a digital map corresponding to the bird's-eye view of FIG. 4A, according to an embodiment.

FIG. 4C is a depiction of a data structure for the digital map corresponding to the bird's-eye view of FIG. 4A, according to an embodiment.

FIG. 5 is yet another bird's-eye view of a roadway, including a schematic representation of various vehicles, according to an embodiment.

FIG. 6 is a flow diagram of an example method of autonomous transport mapping, according to an embodiment.

FIG. 7 is a block diagram illustrating an architecture for a computer system that can be employed to implement elements of the systems and methods described and illustrated herein.

### DETAILED DESCRIPTION

The following detailed description describes various features and functions of the disclosed systems and methods with reference to the accompanying figures. In the figures, similar components are identified using similar symbols, unless otherwise contextually dictated. The exemplary system(s) and method(s) described herein are not limiting, and it may be readily understood that certain aspects of the disclosed systems and methods can be variously arranged and combined, all of which arrangements and combinations are contemplated by this disclosure.

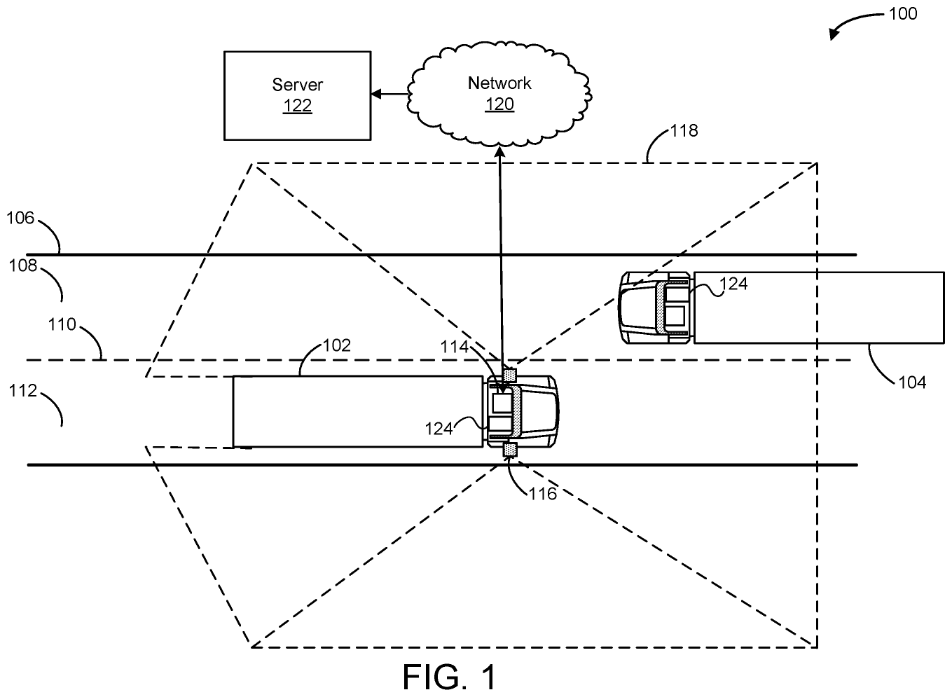

Referring to FIG. 1, the present disclosure may relate to autonomous vehicles, such as an autonomous vehicle 102 having an autonomy system 114. The autonomy system 114 of the vehicle 102 may be completely autonomous (fully autonomous), such as self-driving, driverless, or Level 4 autonomy, or semi-autonomous, such as Level 3 autonomy. An indicated above, some embodiments of the present disclosure may be employed in combination with non-autonomous vehicles. As used herein the term “autonomous” includes both fully autonomous and semi-autonomous. The autonomy system 114 may be structured on at least three aspects of technology: (1) perception, (2) maps/localization, and (3) behaviors planning and control. The function of the perception aspect is to sense an environment surrounding the vehicle 102 and interpret the environment. To interpret the surrounding environment, a perception module 116 or engine in the autonomy system 114 of the vehicle 102 may identify and classify objects or groups of objects in the environment. A presence of such objects, or vehicle operating parameters (e.g., speed, lane position, or so forth) may be referred to as events. A perception module 116 may be associated with various sensors (e.g., light detection and ranging (LiDAR), camera, radar, etc.) of the autonomy system 114 and may identify one or more objects (e.g., pedestrians, vehicles, debris, etc.) and features of the roadway (e.g., lane lines) around the vehicle 102, and classify events based on the objects in the road distinctly. The perception module 116 may determine a presence of other vehicles, or foreign objects and debris along a roadway, vehicle parameters, or so forth.

The maps/localization aspect of the autonomy system 114 may be configured to determine where on a digital map the vehicle 102 is currently located. One way to do this is to sense the environment surrounding the vehicle 102 (e.g., via the perception module 116), such as by detecting vehicles (e.g., a vehicle 104) or other objects (e.g., traffic lights, speed limit signs, pedestrians, signs, road markers, etc.) from data collected via the sensors of the autonomy system 114, and to correlate features of the sensed environment with details (e.g., digital representations of the features of the sensed environment) on the digital map. In some embodiments, at least a portion of the digital map can include pre-established portions such as roadway locations, lane positions, on-ramps, or off-ramps, speed limits, weight restrictions, and so forth. In some embodiments, at least a portion of the digital map can include dynamic elements such as indications of events corresponding to locations on the digital map. The autonomy system 114 may be configured to operate the vehicle based on a combination of pre-established portions and dynamic elements.

Once the systems on the vehicle 102 have determined the location of the vehicle 102 with respect to the digital map features (e.g., location on the roadway, upcoming intersections, road signs, events, etc.), the vehicle 102 can plan and execute maneuvers and/or routes with respect to the features of the digital map. The behaviors, planning, and control aspects of the autonomy system 114 may be configured to make decisions about how the vehicle 102 should move through the environment to get to the goal or destination of the vehicle 102. The autonomy system 114 may consume information from the perception and maps/localization modules to know where the vehicle 102 is relative to the surrounding environment and what other objects and traffic actors are doing.

FIG. 1 further illustrates an environment 100 for modifying one or more actions of the vehicle 102 using the autonomy system 114. The vehicle 102 is capable of communicatively coupling to a remote server 122 via a network 120. The vehicle 102 may not necessarily connect with the network 120 or the server 122 while it is in operation (e.g., driving down the roadway). That is, the server 122 may be remote from the vehicle, and the vehicle 102 may deploy with all the necessary perception, localization, and vehicle control software and data necessary to complete the vehicle 102's mission fully autonomously or semi-autonomously. The vehicle can convey indications of a status to the remote server 122, such as an indication of an event or sensor data which is indicative of an event. The server 122 can convey an indication, via an updated digital map, to further autonomous vehicles 102, which can operate based on the updated digital map.

While this disclosure refers to a vehicle 102 as the autonomous vehicle 102, it is understood that the vehicle 102 could be any type of vehicle including a truck (e.g., a tractor trailer), an automobile, a mobile industrial machine, etc. While the disclosure will discuss a self-driving or driverless autonomous system, it is understood that the autonomous system could alternatively be semi-autonomous having varying degrees of autonomy or autonomous functionality. While the perception module 116 is depicted as being located at the front of the vehicle 102, the perception module 116 may be a part of a perception system with various sensors placed at different locations throughout the vehicle 102, such as to include forward facing a rear facing cameras, radars or time of flight sensors.

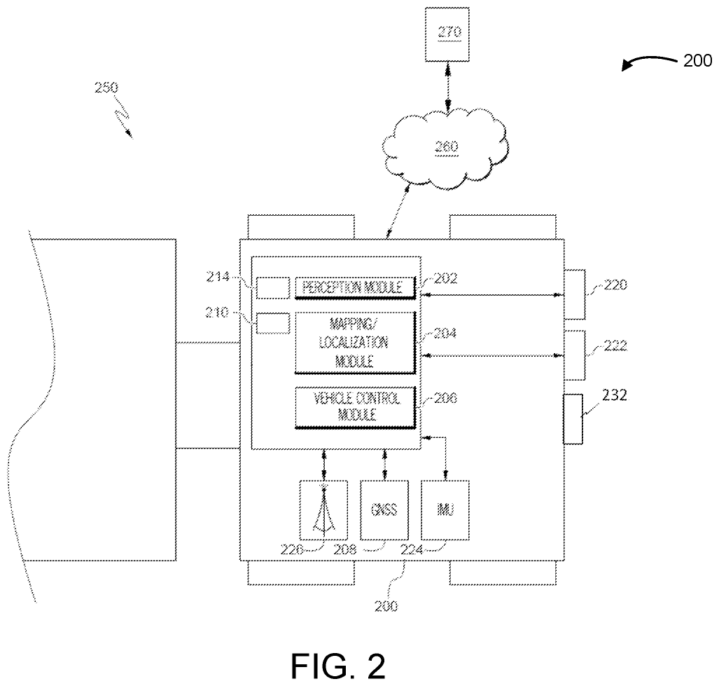

FIG. 2 illustrates an example schematic of an autonomy system 250 of a vehicle 200, according to some embodiments. The autonomy system 250 may be the same as or similar to the autonomy system 114 depicted in FIG. 1. The vehicle 200 may be the same as or similar to the vehicle 102. The autonomy system 250 may include a perception system including a camera system 220, a LiDAR system 222, a radar system 232, a Global Navigation Satellite System (GNSS) receiver 208, an inertial measurement unit (IMU) 224, and/or a perception module 202. The autonomy system 250 may further include a transceiver 226, a processor 210, a memory 214, a mapping/localization module 204, and a vehicle control module 206. The various systems may serve as inputs to and receive outputs from various other components of the autonomy system 250. In other examples, the autonomy system 250 may include additional, fewer, or different components or systems, and each of the components or system(s) may include additional, fewer, or different components. Additionally, the systems and components shown may be combined or divided in various ways. As shown in FIG. 1, the perception systems aboard the autonomous vehicle may help the vehicle 102 perceive the vehicle 102's environment out to a perception area 118. The actions of the vehicle 102 may depend on the extent of the perception area 118. It is to be understood that the perception area 118 is an example area, and the practical area may be greater than or less than what is depicted.

The camera system 220 of the perception system may include one or more cameras mounted at any location on the vehicle 102, which may be configured to capture images of the environment surrounding the vehicle 102 in any aspect or field of view (FOV). The FOV can have any angle or aspect such that images of the areas ahead of, to the side, and behind the vehicle 102 may be captured. In some embodiments, the FOV may be limited to particular areas around the vehicle 102 (e.g., forward of the vehicle 102) or may surround 360 degrees of the vehicle 102. In some embodiments, the image data generated by the camera system(s) 220 may be sent to the perception module 202 and stored, for example, in memory 214. In some embodiments the field of view can be predefined, stored, or otherwise accessible to the processor 210.

The LiDAR system 222 may include a laser generator and a detector and can send and receive LiDAR signals. A LiDAR signal can be emitted to and received from any direction such that LiDAR point clouds (or “LiDAR images”) of the areas ahead of, to the side, and behind the vehicle 200 can be captured and stored as LiDAR point clouds. In some embodiments, the vehicle 200 may include multiple LiDAR systems and point cloud data from the multiple systems may be stitched together.

The radar system 232 may estimate strength or effective mass of an object, as objects made out of paper or plastic may be weakly detected. The radar system 232 may be based on 24 GHz, 77 GHz, or other frequency radio waves. The radar system 232 may include short-range radar (SRR), mid-range radar (MRR), or long-range radar (LRR). One or more sensors may emit radio waves, and a processor may process received reflected data (e.g., raw radar sensor data) from the emitted radio waves.

In some embodiments, the system inputs from the camera system 220, the LiDAR system 222, and the radar system 232 may be fused (e.g., in the perception module 202). For example, the perception module 202 can combine radar data with visible spectrum information to discriminate between an empty bag and an object in the roadway which is relevant to vehicle navigation. The LiDAR system 222 may include one or more actuators to modify a position and/or orientation of the LiDAR system 222 or components thereof. The LiDAR system 222 may be configured to use ultraviolet (UV), visible, or infrared light to image objects and can be used with a wide range of targets. In some embodiments, the LiDAR system 222 can be used to map physical features of an object with high resolution (e.g., using a narrow laser beam). In some examples, the LiDAR system 222 may generate a point cloud and the point cloud may be rendered to visualize the environment surrounding the vehicle 200 (or object(s) therein). In some embodiments, the point cloud may be rendered as one or more polygon(s) or mesh model(s) through, for example, surface reconstruction. Collectively, the radar system 232, the LiDAR system 222, and the camera system 220 may be referred to herein as “imaging systems” along with ultrasonics or other time of flight sensors, or the like.

The GNSS receiver 208 may be positioned on the vehicle 200 and may be configured to determine a location of the vehicle 200 via GNSS data, as described herein. The GNSS receiver 208 may be configured to receive one or more signals from a global navigation satellite system (GNSS) (e.g., a GPS) to localize the vehicle 200 via geolocation. The GNSS receiver 208 may provide an input to and otherwise communicate with the mapping/localization module 204 to, for example, provide location data for use with one or more digital maps, such as an HD map (e.g., in a vector layer, in a raster layer or other semantic map, etc.). In some embodiments, the GNSS receiver 208 may be configured to receive updates from an external network. The updates can include weather data which may be relevant to sensor operation, such as a selection or weighting of a sensor type.

The inertial measurement unit (IMU) 224 may be an electronic device that measures and reports one or more features regarding the motion of the vehicle 200. For example, the IMU 224 may measure a velocity, acceleration, angular rate, and/or an orientation of the vehicle 200 or one or more of the vehicle 200's individual components using a combination of accelerometers, gyroscopes, and/or magnetometers. The IMU 224 may detect linear acceleration using one or more accelerometers and rotational rate using one or more gyroscopes. In some embodiments, the IMU 224 may be communicatively coupled to the GNSS receiver 208 and/or the mapping/localization module 204 to help determine a real-time location of the vehicle 200 and predict a location of the vehicle 200 even when the GNSS receiver 208 cannot receive satellite signals.

The transceiver 226 may be configured to communicate with one or more external networks 260 via, for example, a wired or wireless connection in order to send and receive information (e.g., to a remote server 270). The wireless connection may be a wireless communication signal (e.g., Wi-Fi, cellular, LTE, 5G, etc.). In some embodiments, the transceiver 226 may be configured to communicate with external network(s) via a wired connection, such as, for example, during initial installation, testing, or service of the autonomy system 250 of the vehicle 200. A wired/wireless connection may be used to download and install various lines of code in the form of digital files (e.g., HD digital maps) including events or sensors data associated with the digital maps, executable programs (e.g., navigation programs), and other computer-readable code that may be used by the system 250 to navigate the vehicle 200 or otherwise operate the vehicle 200, either fully autonomously or semi-autonomously.

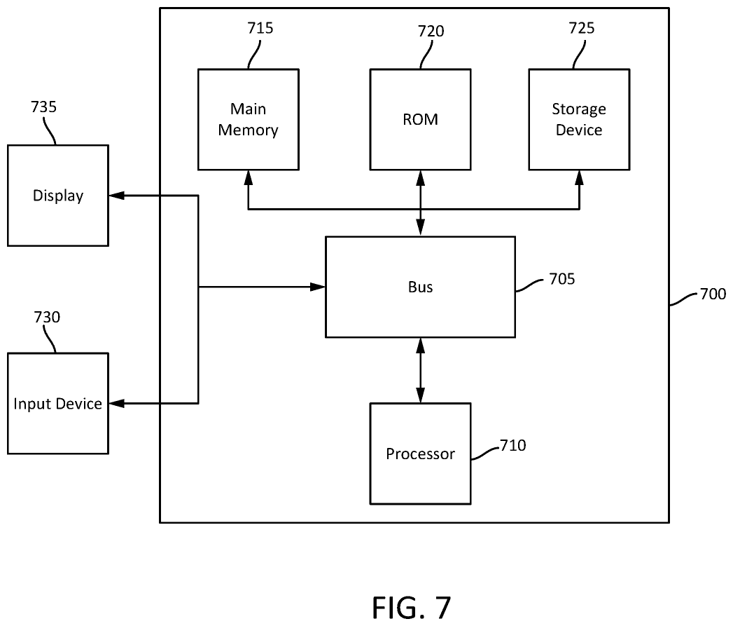

The processor 210 of autonomy system 250 may be embodied as one or more of a data processor, a microcontroller, a microprocessor, a digital signal processor, a logic circuit, a programmable logic array, or one or more other devices for controlling the autonomy system 250 in response to one or more of the system inputs. The autonomy system 250 may include a single microprocessor or multiple microprocessors that may include means for controlling the vehicle 200 to switch lanes and monitoring and detecting other vehicles. Numerous commercially available microprocessors can be configured to perform the functions of the autonomy system 250. The processor 210 can include or interface with the various components of, for example, FIG. 7. It should be appreciated that the autonomy system 250 could include a general machine controller capable of controlling numerous other machine functions. Alternatively, a special-purpose machine controller could be provided. Further, the autonomy system 250, or portions thereof, may be located remote from the system 250. For example, one or more features of the mapping/localization module 204 could be located remote to the vehicle 200. Various other known circuits may be associated with the autonomy system 250, including signal-conditioning circuitry, communication circuitry, actuation circuitry, and other appropriate circuitry.

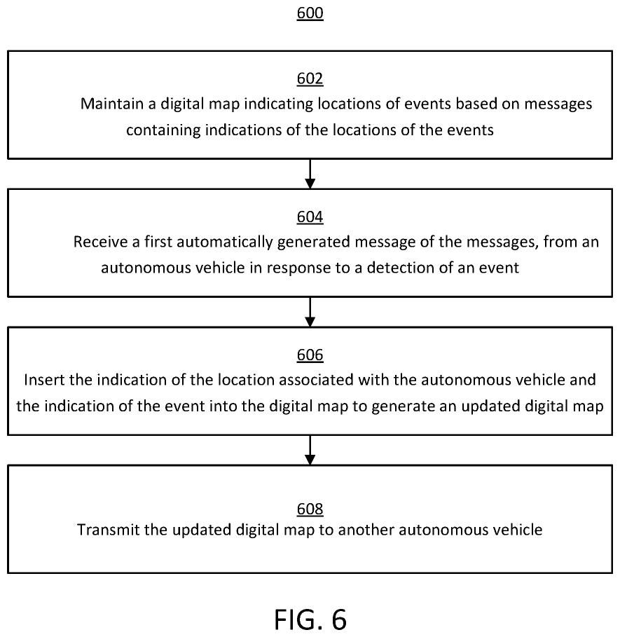

The memory 214 of the autonomy system 250 may store data and/or software routines that may assist the autonomy system 250 or data processing system in performing autonomy system 250's functions, such as the functions of the perception module 202, the mapping/localization module 204, the vehicle control module 206, and the method 600 described herein with respect to FIG. 6. Further, the memory 214 may also store data received from various inputs associated with the autonomy system 250, such as perception data from the perception system. Such instructions can be stored, cached, or retrieved from various transitive or non-transitive medium. For example, the processor 210 can retrieve the instructions from a non-transitive media (e.g., NAND or NOR FLASH, magnetic media, or a read only memory) to execute the instructions. Execution of the instructions can include loading the instructions to another memory (e.g., RAM, including volatile or non-volatile RAM) prior to executing other of the instructions.

As noted above, the perception module 202 may receive input from the various sensors, such as the camera system 220, the LiDAR system 222, the GNSS receiver 208, and/or the IMU 224 (collectively “perception data”) to sense an environment surrounding the vehicle 200 and interpret it. To interpret the surrounding environment, the perception module 202 (or “perception engine”) may identify and classify objects or groups of objects in the environment as one or more event types. For example, the vehicle 102 may use the perception module 202 to identify one or more objects (e.g., pedestrians, vehicles, debris, etc.) or features of the roadway 106 (e.g., intersections, road signs, lane lines, etc.) before or beside a vehicle and classify the objects in the road. In some embodiments, the perception module 202 may include an image or video classification function and/or a computer vision function. In some embodiments, the perception module 202 can include a rain sensor, temperature sensor, of other indications of local environmental conditions.

The system 250 may collect perception data. The perception data may represent the perceived environment surrounding the vehicle, for example, and may be collected using aspects of the perception system described herein. The perception data can come from, for example, one or more of the LiDAR system, the camera system, the radar system and various other sensors and systems on board the vehicle (e.g., the GNSS receiver, etc.). For example, in vehicles having a sonar or radar system, the sonar and/or radar systems may collect perception data. As the vehicle 102 travels along the roadway 106, the system 250 may continually receive data from the various systems on the vehicle 102. In some embodiments, the system 250 may receive data periodically and/or continuously. With respect to FIG. 1, the vehicle 102 may collect perception data that indicates the presence of the lane line 110 (e.g., in order to determine the lanes 108 and 112). Additionally, the detection systems may detect the vehicle 104 and monitor the vehicle 104 to estimate various properties of the vehicle 104 (e.g., proximity, speed, behavior, flashing light, etc.). The properties of the vehicle 104 may be stored as time-series data in which timestamps indicate the times in which the different properties were measured or determined. The features may be stored as points (e.g., vehicles, signs, small landmarks, etc.), lines (e.g., lane lines, road edges, etc.), or polygons (e.g., lakes, large landmarks, etc.) and may have various properties (e.g., style, visible range, refresh rate, etc.), which properties may control how the system 250 interacts with the various features.

The image classification function may determine the features of an image (e.g., a visual image from the camera system 220 and/or a point cloud from the LiDAR system 222). The image classification function can be any combination of software agents and/or hardware modules able to identify image features and determine attributes of image parameters in order to classify portions, features, or attributes of an image corresponding to one or more events. The image classification function may be embodied by a software module that may be communicatively coupled to a repository such as the memory 214, of images or image data (e.g., visual data and/or point cloud data) which may be used to determine objects and/or features in real-time image data captured by, for example, the camera system 220 and the LiDAR system 222. In some embodiments, the image classification function may be configured to classify features based on information received from only a portion of the multiple available sources. For example, in the case that the captured visual camera data includes images that may be blurred, the system 250 may identify objects based on data from one or more of the other systems (e.g., the LiDAR system 222) that does not include the image data.

The computer vision function may be configured to process and analyze images captured by the camera system 220 and/or the LiDAR system 222 or stored on one or more modules of the autonomy system 250 (e.g., in the memory 214), to identify objects and/or features in the environment surrounding the vehicle 200 (e.g., lane lines). The computer vision function may use, for example, an object recognition algorithm, video tracing, one or more photogrammetric range imaging techniques (e.g., a structure from motion (SfM) algorithms), or other computer vision techniques. The computer vision function may be configured to, for example, perform environmental mapping and/or track object vectors (e.g., speed and direction). In some embodiments, objects or features may be classified into various event classes using the image classification function, for instance, and the computer vision function may track the one or more classified objects to determine aspects of the classified object (e.g., aspects of the vehicle 200's motion, size, etc.).

The mapping/localization module 204 receives perception data that can be compared to one or more digital maps stored in the mapping/localization module 204 to determine where the vehicle 200 is in the world and/or where the vehicle 200 is on the digital map(s). In particular, the mapping/localization module 204 may receive perception data from the perception module 202 and/or from the various sensors sensing the environment surrounding the vehicle 200 and correlate features of the sensed environment with details (e.g., digital representations of the features of the sensed environment) on the one or more digital maps. The digital map may have various levels of detail and can be, for example, a raster map, a vector map, etc. The digital maps may be stored locally on the vehicle 200 and/or stored and accessed remotely. Various instances of the digital maps may be stored at various locations, each of the various instances including same or varying information.

The vehicle control module 206 may control the behavior and maneuvers of the vehicle 200. For example, once the systems on the vehicle 200 have determined the vehicle 200's location with respect to map features (e.g., intersections, road signs, lane lines, etc.) the vehicle 200 may use the vehicle control module 206 and the vehicle 200's associated systems to plan and execute maneuvers and/or routes with respect to the features of the environment. The vehicle control module 206 may make decisions about how the vehicle 200 will move through the environment to get to the vehicle 200's goal or destination as it completes the vehicle 200's mission. The vehicle control module 206 may consume information from the perception module 202 and the mapping/localization module 204 to know where it is relative to the surrounding environment and what other traffic actors are doing.

The vehicle control module 206 may be communicatively and operatively coupled to a plurality of vehicle operating systems and may execute one or more control signals and/or schemes to control operation of the one or more operating systems, for example, the vehicle control module 206 may control one or more of a vehicle steering system, a propulsion system, and/or a braking system. The propulsion system may be configured to provide powered motion for the vehicle 200 and may include, for example, an engine/motor, an energy source, a transmission, and wheels/tires and may be coupled to and receive a signal from a throttle system, for example, which may be any combination of mechanisms configured to control the operating speed and acceleration of the engine/motor and thus, the speed/acceleration of the vehicle 200.

The steering system may be any combination of mechanisms configured to adjust the heading (e.g., the direction) of the vehicle 200. The brake system may be, for example, any combination of mechanisms configured to decelerate the vehicle 200 (e.g., friction braking system, regenerative braking system, etc.). The vehicle control module 206 may be configured to avoid obstacles in the environment surrounding the vehicle 200 and may be configured to use one or more system inputs to identify, evaluate, and modify a vehicle trajectory. The vehicle control module 206 is depicted as a single module, but can be any combination of software agents and/or hardware modules able to generate vehicle control signals operative to monitor systems and control various vehicle actuators. The vehicle control module 206 may include a steering controller for vehicle lateral motion control and a propulsion and braking controller for vehicle longitudinal motion.

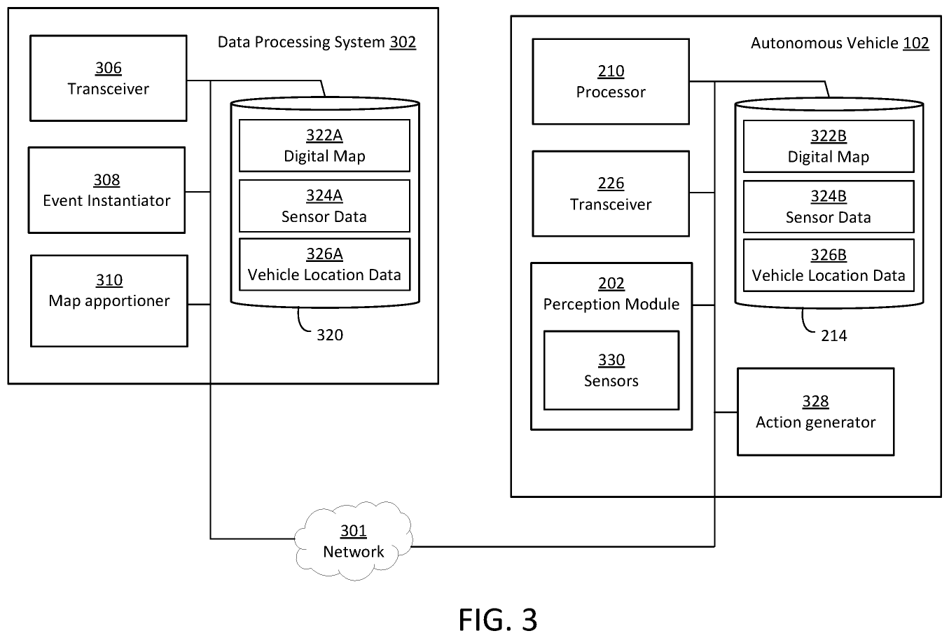

Referring now to FIG. 3, an example block diagram for a system 300 for autonomous transport mapping is provided. The system 300 can include, interface with or otherwise communicate with one or more data processing systems 302. In some cases, the data processing system 302 can be referred to, include, or be hosted by a server such as the remote server 270/122 of FIG. 1 or FIG. 2, or an autonomous vehicle 102. The system 300 can include, interface with or otherwise communicate with various autonomous vehicles 102. The data processing systems 302, and autonomous vehicles 102 can communicate via a network 301. The network 301 can include computer networks such as the Internet, local, wide, metro, or other area networks, intranets, cellular networks, satellite networks, and other communication networks such as voice or data mobile telephone networks.

The data processing system 302 can include at least one transceiver 306. The data processing system 302 can include at least one event instantiator 308. The data processing system 302 can include at least one map apportioner 310. The data processing system 302 can include at least one data repository 320. Each of the transceiver 306, event instantiator 308, and map apportioner 310 may each include or interface with at least one processing unit or other logic device such as a programmable logic array engine, or module configured to communicate with the data repository 320 or database, such as one or more component of FIG. 7.

The data repository 320 can include one or more local or distributed databases, and can include a database management system. The data repository 320 can include computer data storage or memory and can store one or more of a digital map 322, sensor data 324, or vehicle location data 326. More particularly, the data repository 320 can include instances, versions, or portions of the digital map 322A, sensor data 324A, and vehicle location data 326A which may differ from further instances of such data stored on various network connected devices, such as the digital map 322B, sensor data 324B, and vehicle location data 326B stored at memories 214 of various autonomous vehicles 102 in network communication with the data processing system 302.

The digital map 322A may include or refer to a data structure including event and location data received from various autonomous vehicles 102. The digital map 322A may further include road data, speed limit or typical speed data, or route information (e.g., a route which for a class 8 truck). The digital map 322A can include historical data such as historical locations of animal strikes, collisions, congestion, or other events). A digital map 322 can be maintained for all or a portion of a monitored region. For example, an autonomous vehicle 102 can maintain (e.g., store or update) a digital map 322B for a location proximal to the autonomous vehicle 102, or along a planned route for the autonomous vehicle 102. The proximity may be determined according to a location in a same or adjacent grid square or municipality, within a defined radius or other bounding line, or the like. A data processing system 302 can maintain a digital map 322A for a predefined area of operation or based on a location of one or more autonomous vehicles 102 in network communication with the data processing system 302. Another data processing system 302 can maintain a digital map 322A for another area of operation, such as according to a mesh or hierarchical structure. For example, the respective data processing systems 302 can maintain separate, overlapping, or duplicative digital maps 322.

In some embodiments, the various digital maps 322 can include, omit, or substitute information including events and locations. Any portion of a digital map 322 (e.g., geographic portion, temporal portion, or so forth) may also be referred to as a digital map 322. For example, a digital map 322 for a state can include sub portions such as a municipality, distance from a centroid, or grid squares. For example, a digital map 322 for Texas can include a digital map 322 for Austin, among other constituent digital maps 322. The digital map 322 can include a time, confidence, or other information associated with each event of the digital map 322 which may be omitted in a conveyance of the digital map 322 to one or more autonomous vehicles 102 (e.g., to reduce a file size of the portion of the transferred digital map 322). In some embodiments, the data processing system 302 can include a time associated with an event such that the data processing system 302 can thereafter omit an update upon a timeout of a feature of the digital map 322 (e.g., wherein the autonomous vehicle 102 is configured to update a received digital map 322 to prune expired events).

Sensor data 324 may include or refer to any data from a sensor 330 of the perception module 202. For example, the sensor data 324 can include image data for a roadway, vehicle speed, position, actions of other vehicles 104 on or proximate to a roadway, or so forth. Sensor data 324 can include various indications of events on or proximal to a roadway. For example, the sensor data 324 can include images having edges or distances indicative of a location, size, type, or other attribute of an event. The sensor data 324 can include an indication of a sensor type, position, model, field of view, orientation, or other sensor data 324. Such sensor data 324 may be employed, by the data processing system 302, to determine a relative position of indicia of events relative to an autonomous vehicle 102. For example, an object detected in a left or right facing imaging sensor can be indicative of a location along a roadway for the event. Thus, the combination of sensor orientation, roadway markings, or event indicia of the sensor data 324 can, in various combinations, indicate event information. The various references to sensor data 324 included herein may refer to any combination of descriptor information for the sensor, the roadway or roadway markings, or indications of the event (e.g., objects in the roadway, presence of emergency vehicles, roadway markings, etc.). Although referring to the sensors 330 of a perception module 202 herein, the various messages including sensor data 324 can include other vehicle information such as speeds, coolant temperatures, occupancy, or so forth.

Vehicle location data 326 may include or refer to location information received from an autonomous vehicle 102. Some vehicle location data 326 may identify a location of the autonomous vehicle 102 itself, which may be referred to as vehicle centered vehicle location data 326. Such vehicle location data 326 can include mile markers, GNSS locations, cellular towers, or other wireless network devices in communication therewith, or the like. Vehicle location data 326 can include locations of events associated with the autonomous vehicle 102. Such locations can be provided as absolute locations (e.g., the autonomous vehicle 102 can determine an event location based on a vehicle centered location and a relative offset therefrom). Some locations can be provided to the data processing system 302 as relative locations. For example, the autonomous vehicle 102 can provide sensor data 324 along with a vehicle centered vehicle location data 326, whereupon the data processing system 302 can determine an absolute location of the event. In some embodiments, the data processing system 302 can maintain and transmit a relative location to another autonomous vehicle 102. For example, the other autonomous vehicle 102 can determine a sensor or position of a sensor FOV based on the relative location.

As used herein, references to digital maps 322, sensor data 324, and vehicle location data 326 may be referred to as stored in a data processing system 302 (e.g., by inclusion of an ‘A’ suffix), or referred to as stored in an autonomous vehicle 102 (e.g., by inclusion of an ‘B’ suffix). Such references are merely intended to provide clarity to data referred to in particular examples including various autonomous vehicles 102 and at least one data processing system 302. Such indications are not intended to be limiting. For example, in some embodiments, further vehicles can include further instances of such information; in some embodiments, each autonomous vehicle 102 or data processing system 302 can store duplicated data. Indeed, as indicated above, in some embodiments, the data processing system 302 may be hosted by at least one autonomous vehicle 102.

The data processing system 302 can include at least one transceiver 306 to exchange information with various autonomous vehicles 102. For example, the transceiver 306 can be configured to interface with a corresponding transceiver 226 of the one or more autonomous vehicles 102 via one or more wired or wireless connections. The transceiver 306 can receive information according to a predefined format, such as a format including an identifier, location, or other attribute of the autonomous vehicle 102, along with an indication of an event. Likewise, the transceiver 306 can convey a digital map 322A to one or more autonomous vehicles 102 based on an identifier, location, or other attribute of the autonomous vehicle 102. In some embodiments, the transceiver 306 can extract information from frames, packets, or other data structures for provision to the event instantiator 308.

The at least one transceiver 306 can include a wired or wireless connection between the autonomous vehicles 102 and the server 122 or other system 300 components hosting the data processing system 302. The wired or wireless connection can be or include the various connection types of the transceiver 226 of the vehicle 200 (e.g., the autonomous vehicle 102). For example, the transceiver 306 may be in network communication with the transceiver 226 of the vehicle 200 over a same network 120 or network connection type (e.g., Wi-Fi, cellular, Ethernet, CAN, or the like).

In some embodiments, the event instantiator 308 can determine an event based on an indication thereof, the indication based on sensor data 324A accessible to the data processing system 302. For example, the event instantiator 308 can receive sensor data 324A from the autonomous vehicle 102 and determine the existence or type of the event therefrom. In some embodiments, the sensor data 324A can be a streaming output of one or more sensors 330 of the autonomous vehicles 102. For example, the autonomous vehicle 102 can stream imaging data, speed data, or the like to the data processing system 302. The stream data can include all or a subset of information captured by the sensor 330.

In an example, the autonomous vehicle 102 can apply an edge detection technique to define an object on a roadway or other technique to determine a potential event, and convey an image, video file, dimension, outline, or other indication of the event. Upon receipt of the information, the data processing system 302 can process the information to determine an existence or type of the object. For example, the processing system 302 can determine the existence of an event of debris on a roadway, standing water on a roadway, or so forth, based on the initial indication provided by the autonomous vehicle 102. That is to say that the autonomous vehicle 102 can determine anomalies in sensor data 324 and provide the sensor data 324 or indications based thereupon to the data processing system 302 to determine events based on the anomalies. Some anomalies may not be indicative of events (e.g., a worn roadway marking, differently colored section of roadway surface, or other anomaly), but may be conveyed to the data processing system 302 for such a determination.

In some embodiments, the sensor data 324A (or information derived therefrom which is indicative of an event) received from an autonomous vehicle 102 can be stored, in the data repository 320, by the event instantiator 308. Further sensor data 324 (or further information indicative of the event) received from further autonomous vehicles 102 can be received and compared to the stored sensor data 324A of the data processing system 302. For example, the data processing system 302 can compare a position, size, or other characteristic of an object in or alongside the roadway, vehicle speed, traffic density, or other indication of the event. The comparison can indicate, for example, an expansion of a pothole, a movement of an object between or within a lane or shoulder of a roadway, or so forth. In some embodiments, the comparisons can be based on a sensor type. For example, a comparison of sensor data 324 received from two autonomous vehicles 102 having a same sensor type and orientation can be employed to compare a time-series movement or change corresponding to an event (e.g., a change in traffic flow patterns). In another example, a comparison of sensor data 324 received from two autonomous vehicles 102 having a different sensor type or orientation can be employed to determine information corresponding to the event based on the different sensor types or positions. For example, sensor data 324 of an object in the roadway from varying sensor orientations can be employed to generate a three-dimensional model of the object.

In some embodiments, the indication of the event is determined by the autonomous vehicle 102, and thereafter conveyed to the data processing system 302. For example, the autonomous vehicle 102 can detect an event such as traffic congestion, an object in the roadway, or a collision alongside of a roadway. Such a determination may decrease network congestion on a link between the data processing system 302 and the one or more autonomous vehicles 102, relative to embodiments which stream image data to the data processing system 302, though the data processing system 302 may receive less information such as sensor data 324 for comparison to information received from other vehicles. In various embodiments, a combination of edge processing at the various autonomous vehicles 102 and processing at, for example, a remote server 122 hosting at least some elements of the data processing system 302 may be employed. For example, the autonomous vehicle 102 can locally process data to take a local action, such as a navigational action including a change to speed or direction in response to the event and convey sensor data 324 or other indications of the event or potential event to the data processing system.

In some embodiments, the autonomous vehicle 102 can provide an indication of the navigational action taken, such as a change of speed or direction which may be relevant to other autonomous vehicles 102 in network communication with the data processing system 302. For example, an autonomous vehicle 102 which performs a navigational action to slow prior to striking a potential object in a roadway may be relevant to further autonomous vehicles 102, since further indicia of the event (e.g., sensor data 324 of a rear facing camera) may show a deformability or non-deformability of the object. Accordingly, the data processing system 302 may discriminate between a relatively benign deformable object (e.g., a tire carcass or empty bag) with a metal coil or section of steel cable. In some embodiments, the data processing system 302 may provide an indication of a navigational action taken or not taken by other vehicles 104 based on the sensor data 324 collected by the autonomous vehicle 102. For example, an indication that other vehicles 104 (e.g., human piloted vehicles, or other autonomous vehicles 102 operating with a different sensor suite, or which are not in network communication with a same data processing system) are not changing a speed or direction proximal to a potential object, collision, or the like may indicate that the object in the roadway may be a reflection, shadow, or other spurious observance.

The event instantiator 308 can determine an existence of an event based on a message received from the autonomous vehicle 102 indicating the existence of the event, or information derived from sensor data 324 collected by the autonomous vehicle 102. For example, the data processing system 302 can receive sensor data 324 such as image data depicting an object in, alongside, or otherwise proximal to a roadway. In another example, the data processing system 302 can receive information derived from sensor data 324 collected by the autonomous vehicle 102, such as an indication that a portion of a roadway is blocked by a foreign object, and may further include an object description (e.g., “roadway wildlife casualty,” “pothole,” or “vehicle collision.”)

Any sensor data 324 conveyed can include or be provided along with vehicle location data 326. The data processing system 302 can determine an event location based on the vehicle location data 326. In some embodiments, the data processing system 302 can determine an event based on time-series data, such as a location of an autonomous vehicle 102 over time to indicate a congestion event. In some embodiments, the data processing system 302 can determine an event based on the relative location data for an event in combination with the vehicle location. For example, a mile-marker, GNSS, or other vehicle centered location can determine an approximate location for an event. A sensor direction, range, or other of the vehicle location data 326 can include the position of an event relative to the vehicle centered location. The data processing system 302 can determine a digital map location based on the vehicle centered location and the position of the event relative to the vehicle centered location. The autonomous vehicle 102 can provide further data along with any sensor data 324 described herein. For example, the autonomous vehicle 102 can include an indication of traffic speed or density, a description or attribute of an object on a roadway, or a presence of emergency vehicles at a scene of a collision. Further, the data processing system 302 can associate a time with each message or indication of an event received from the autonomous vehicles 102. The time can be a time of capture of data by a sensor 330, a time of transmission by the autonomous vehicle 102, a time of receipt by the data processing system 302, or so forth.

The data processing system 302 can determine a confidence (e.g., confidence level or confidence interval) of an event based on any received indications, sensor data 324, times, vehicle location data 326, or other information. Some confidences can be compared to one or more confidence thresholds. For example, a threshold may be conveyed to the map apportioner 310, described hereinafter, which may employ the comparisons to determine whether to update a digital map 322, whether to report an event to one or more autonomous vehicles 102, or whether an indication of confidence should be conveyed to the one or more autonomous vehicles 102. Some confidences may be time variable or include timeouts. For example, an indication of an object in a roadway can be associated with a timeout of one hour; an indication of a road hazard pothole can be associated with a timeout of one year. A timeout can be separate from or integrated with another confidence interval. For example, a time expired may be a Boolean indication of timeout, or the event instantiator 308 may assign the time a weight, and adjust a confidence based on the amount of elapsed time.

In some instances, the event instantiator 308 can determine an event is existent, is of a particular type, or exceeds a threshold based on information from multiple autonomous vehicles 102. For example, a confidence, event, or location can be adjusted responsive to updated information such as sensor data 324, indications derived therefrom, or comparisons therebetween, wherein the sensor data 324 can originate from various autonomous vehicles 102.

The data processing system 302 can include at least one map apportioner 310 to maintain and distribute the digital map 322. For example, the map apportioner 310 can update the digital map 322 by addition, adjustment, or removal of events or corresponding locations therefrom. The map apportioner 310 can receive an event from the event instantiator 308, along with a time, confidence, or location. The map apportioner 310 can assign a label to an event corresponding to a location upon receipt of such data. For example, the map apportioner 310 can update the digital map 322 (e.g., generate an updated digital map 322) to include an event at a location received from the event instantiator 308.

The map apportioner 310 can remove an event responsive to a comparison of the event to a confidence threshold. The confidence threshold can be a predetermined threshold, stored by an autonomous vehicle 102 or data processing system 302. The removal can be based on a confidence corresponding to event existence or location. In some embodiments, the map apportioner 310 can adjust an event size based on a number of potential events or event locations. For example, responsive to multiple instances of locations corresponding to events of debris on a roadway, the map apportioner 310 can apportion the digital map 322 to include a distance (e.g., a mile) along a route with the location, or can update a location (e.g., generate an updated digital map 322 omitting a prior location and adding a new location).

In some embodiments, the map apportioner 310 can remove an event responsive to an update from an autonomous vehicle 102. The removal can be based on a comparison of a location for the event. Previously received sensor data 324 or indications derived therefrom can be compared to sensor data 324 from another vehicle (e.g., by the data processing system 302 or the other autonomous vehicle 102). For example, the first autonomous vehicle 102 can detect a pothole along a roadway. The first autonomous vehicle 102 or the data processing system 302 can determine that a road hazard event corresponds to the pothole based on a comparison to a lateral size, location, depth, or other attribute/threshold. The map apportioner 310 can add the event to the digital map 322. Thereafter, the other autonomous vehicle 102 can detect a same portion of the roadway. The autonomous vehicle 102 or the data processing system 302 can determine that the sensed portion of the roadway is the same (e.g., that the pothole is not obscured by inclement weather or other vehicles 104) and update the digital map 322 to remove the indication of the pothole. The map apportioner 310 can further transmit the updated digital map 322 to various further autonomous vehicles 102.

In some embodiments, removal of an event can indicate setting a flag that the event is non-active. That is, the event can be maintained such that the event is not conveyed to autonomous vehicles 102, but can be processed, analyzed, or parsed for other purposes. For example, the event instantiator 308 can determine a confidence for an active event based on a number of corresponding non-active events in proximity to a location corresponding to the active event (e.g., an area with frequent deer-strikes may be indicative of a confidence of a subsequent deer strike).

The map apportioner 310 can cause the transceiver 306 to transmit updated digital maps 322 to any autonomous vehicle 102. For example, the map apportioner 310 can cause the transceiver 306 to transmit a digital map 322 to all autonomous vehicles 102 in network communication therewith or based on location data associated with the various vehicles. For example, the map apportioner 310 can receive a location associated with vehicles and convey an update including an event to all vehicles within a proximity of a location corresponding to the event. The proximity can be based on a distance to a reporting vehicle, or another location associated with the event (e.g., mile marker 167 or twenty meters northeast of the roadway at mile marker 167). The vehicle distances can be based on a radius having a centroid at the location corresponding to the event, a grid square or number of grid squares, a distance along a route, an expected time of arrival at the event, or other indicia of proximity.

As indicated above, the autonomous vehicle 102 can include at least one processor 210, transceiver 226, autonomy system 250/action generator 328, perception module 202, and memory 214. Each of the processor 210, transceiver 226, autonomy system 250/action generator 328, or perception module 202 may each include or interface with at least one processing unit or other logic device such as a programmable logic array engine, or module configured to communicate with the memory 214 or database. With further reference to the processor 210 of the autonomous vehicle 102, the processor 210 can schedule, execute, or cause the various operations described with regard to the autonomous vehicle 102. For example, the processor 210 can be or include one or more processors to execute operations described with regard to the transceiver 226, autonomy system 250/action generator 328, or perception module 202. The various references, herein, to processors, controllers, data processors, microcontrollers, microprocessors, digital signal processors, logic circuits, or programmable logic arrays may refer to a processor 210 of the autonomous vehicle 102 or the data processing system 302. References to, for example, a microprocessor, processor, or controller are nonlimiting, and may refer to one or more same or varied logic elements. In various embodiments, certain of the operations performed by the autonomous vehicle 102 or the data processing system 302 can be performed by the other of the data processing system 302 or autonomous vehicle 102.

With further reference to the transceiver 226 of the autonomous vehicle 102, the transceiver 226 can automatically generate message in response to a detection of an event. The automatic generation may refer to a generation and conveyance which is executed without human action. For example, the transceiver 226 may be a transceiver 226 of an uncrewed autonomous vehicle 102 or may omit a presentation of the message to a crew of a crewed vehicle. The automatically generated message can include an indication of a location associated with the event, such as a vehicle centered location, absolute location of the event, or relative location of the event. The indication can be or include sensor data 324 or information derived therefrom. Likewise, the automatically generated message can include an indication of the event, which can include an event type, classification, sensor data 324, or other indications.

With further reference to the perception module 202 of the autonomous vehicle 102, the perception module 202 can include any of the various sensors described with regard to FIG. 1 or FIG. 2, or other sensors 330 of an autonomous vehicle 102. The sensors 330 can be identified according to a model, position, suite version, or so forth. The sensors 330 can refer to one or more sensors 330 which are employed to detect a shape, material, specularity or reflectivity, or other properties of an event or an object associated with the event. In some embodiments, the sensor data 324 can include an indication of vehicle speed, coolant temperature, tire pressure, or the like. For example, references to sensors 330 may further include reference to wheel speed sensors, engine speed sensors, or the like. That is, references to the sensors 330 of the autonomous vehicle 102 may include sensors associated with the vehicle control module 206 or other vehicle systems as well as sensors of the perception module 202, to the extent that such sensors 306 are indicative of an event (e.g., a tire pressure sensor can indicate a presence of a road hazard related to flat tires).

With further reference to the action generator 328 of the autonomous vehicle 102, the at least one action generator 328 can cause any autonomous vehicles (e.g., the autonomous vehicle 102) having a perception area 118 including an event or indicia thereof, or another autonomous vehicle 102 in network communication therewith, to execute a navigational action. A navigational action may include or refer to a change in speed or direction. For example, the change in speed may correspond to a speed restriction (e.g., a speed restriction which is less than a current or planned speed). Likewise, a lane restriction or preference can cause the autonomous vehicle 102 to change a lane, or the autonomous vehicle 102 may proceed along a different roadway, or a different portion of the roadway. For example, the autonomous vehicle 102 may proceed along a different lane or a different portion of a lane to avoid a collision, intersection, or other interface with the event or the location corresponding thereto.

In various embodiments, the action can be selected by an autonomous vehicle 102 upon detection by sensors 330 thereof or based on a receipt of a message from the data processing system 302 such as a message indicative of the event, or based on a combination of information in a message received from the data processing system 302 with a detection of corresponding information by sensors 330 of the autonomous vehicle 102.

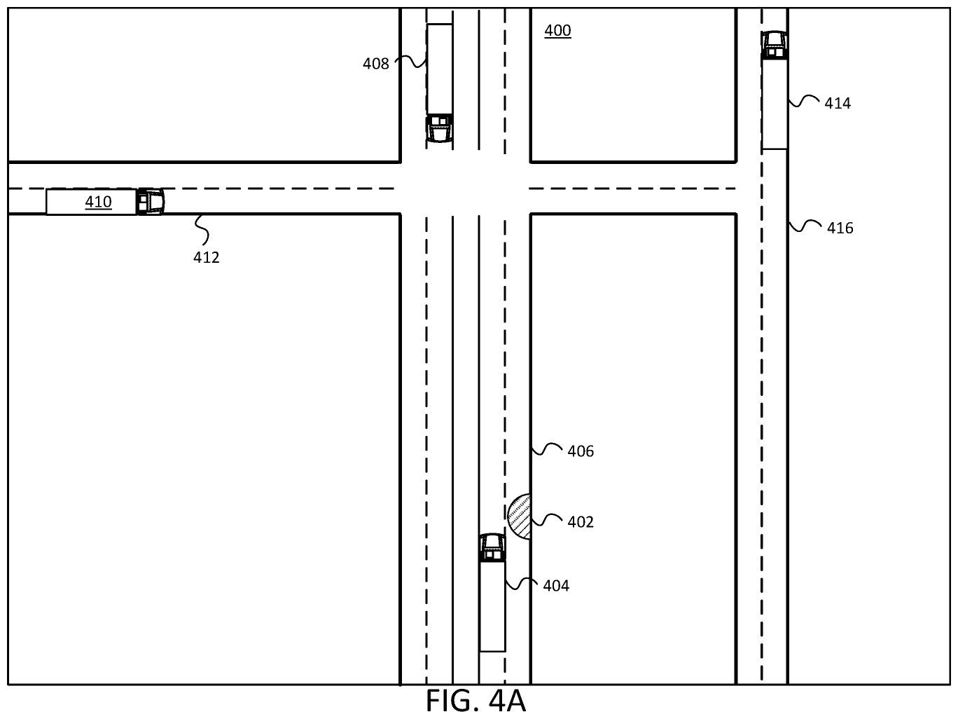

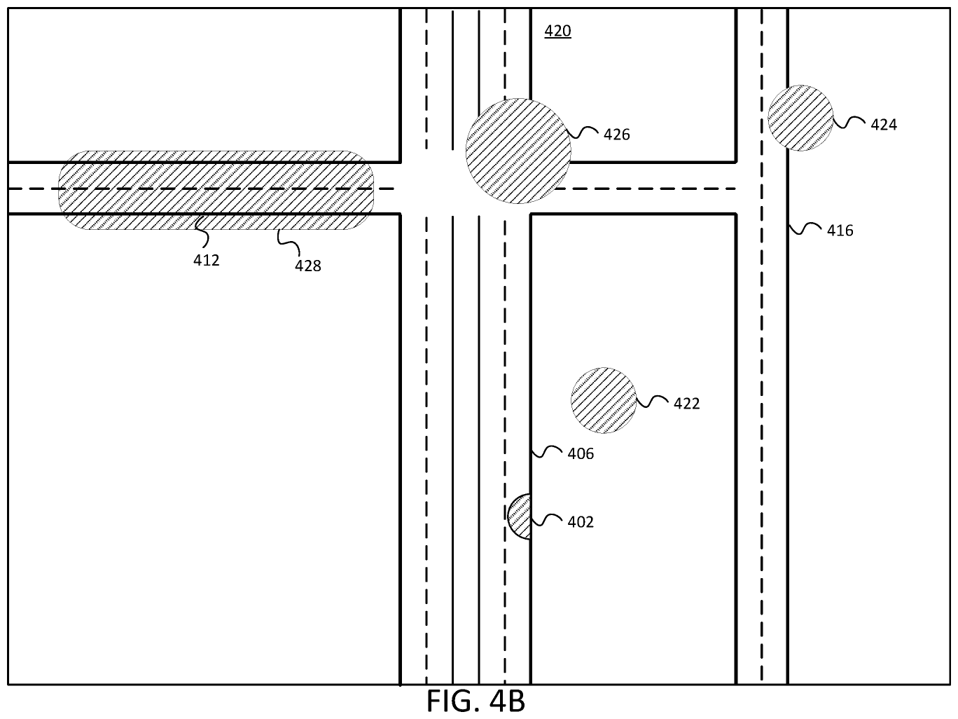

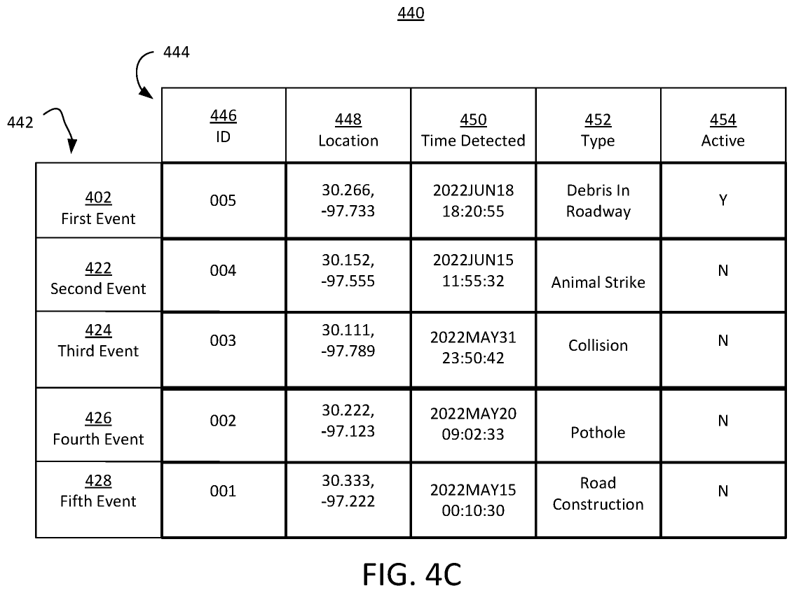

Referring to FIG. 4A, another bird's-eye view 400 of a roadway, including a schematic representation of various vehicles is provided, according to an embodiment. An event 402 is depicted within a perception area 118 of a first autonomous vehicle 404. As depicted, the event 402 corresponds to a location which is ahead of and to the right of the first autonomous vehicle 404. The event 402 is shown as in a rightmost lane of a first roadway 406 which the first autonomous vehicle 404 traverses. The first autonomous vehicle 404 can automatically generate and transmit a message indicative of the event 402 to a data processing system 302 (not depicted) which is remote from the vehicle, via a wireless transceiver 226 of the vehicle. The message can include sensor data 324 associated with the event 402, information corresponding to the vehicle sensors 330, or so forth.

The data processing system 302 can be in network communication with the first autonomous vehicle 404 navigating the first roadway 406, along with a second autonomous vehicle 408 navigating the first roadway 406 in an opposite direction, so as to approach the event 402 from another direction, or a third autonomous vehicle 410 navigating a second roadway 412 in a direction approaching the first roadway 406. In some embodiments, the data processing system 302 can receive, from the second autonomous vehicle 408 or third autonomous vehicle 410, an indication of a route. For example, the data processing system 302 can receive an indication, from the second autonomous vehicle 408 of whether the second autonomous vehicle 408 will proceed along a route to a position laterally aligned with the event, or traverse another route, such as turning onto the second roadway 412. Likewise, the data processing system 302 can receive an indication, from the third autonomous vehicle 410, of a route, and can determine whether the event 402 is relevant to the route. The data processing system 302 may further be in communication with the fourth autonomous vehicle 414, traversing a third roadway 416 which does not intersect with the first roadway 406 along a heading away from the event 402.

FIG. 4B is a graphical representation of a digital map 322 corresponding to the bird's-eye view 400 of FIG. 4A, according to an embodiment. The digital map 322 includes various identified events. For example, along with the first event 402 depicted in FIG. 4A, a second event 422 alongside of the first roadway 406, a third event 424 on and alongside the third roadway 416, and a fourth event 426 alongside the intersection of the first roadway 406 and the second roadway 412 are depicted. Locations corresponding to each of the second 422, third 424, and fourth 426 events are depicted as radially defined about a centroid for the respective events. A location corresponding to the fifth event 428 extends along a roadway (the second roadway 412). As depicted, various locations can correspond to various areas, which may correspond to varying location confidence, or various event sizes. In various embodiments, further location sizes, types, or dispositions can be mapped.

FIG. 4C is a depiction of a data structure 440 for the digital map 322 corresponding to the bird's-eye view 400 of FIG. 4A, according to an embodiment. The data structure 440 includes an event column 442 including each of the first 402, second 422, third 424, fourth 426, and fifth events 428. The data structure 440 can include an identification row 444 or other identification of various further columns including information related to the various events. As depicted in the non-limiting example, the data structure 440 includes an identification column 446 to identify an event. In some embodiments, the identification column 446 can include a depiction an original identification or an adjustment to an event. For example, identified events which are merged, adjusted, or removed may maintain an original identifier, or may receive a new identifier. A location column 448 can correlate each event to a location. A location can include a grid, radius around a centroid, length along a roadway, or other location. For example, the data structure 440 can include further columns indicating a radius, distance, or other dimension. The location can be or include any location of or based on vehicle location data 326.

A detection time column 450 can depict a time of detection for an event. As indicated above, the detection time may relate to a detection by the autonomous vehicle 102, or by the data processing system 302. In some embodiments, further times such as expiration times, or further detection times can be employed. In some embodiments, a data structure 440 can be associated with an update time, such that repeated events are not conveyed, to reduce network congestion (e.g., a detection time of each event can be compared to an update time for the instance of the data structure 440). A type column 452 can relate to an identified event type. Although depicted as descriptive text, the event type may be stored according to various formats, such as a pointer to a predefined event type, and can further include or be associated with a confidence value (not depicted) associated with one or more event types. For example, the indication of debris in roadway associated with the first event 402 can correspond to a confidence, and another event type (e.g., shadows, puddles, or graffiti) can be associated with a lower confidence, such that the debris in roadway description is selected. A status column 454 can indicate whether an event is presently active or non-active. The data processing system 302 can omit non-active events from transmissions, which may reduce edge processing or throughput employed by the systems and methods disclosed herein.

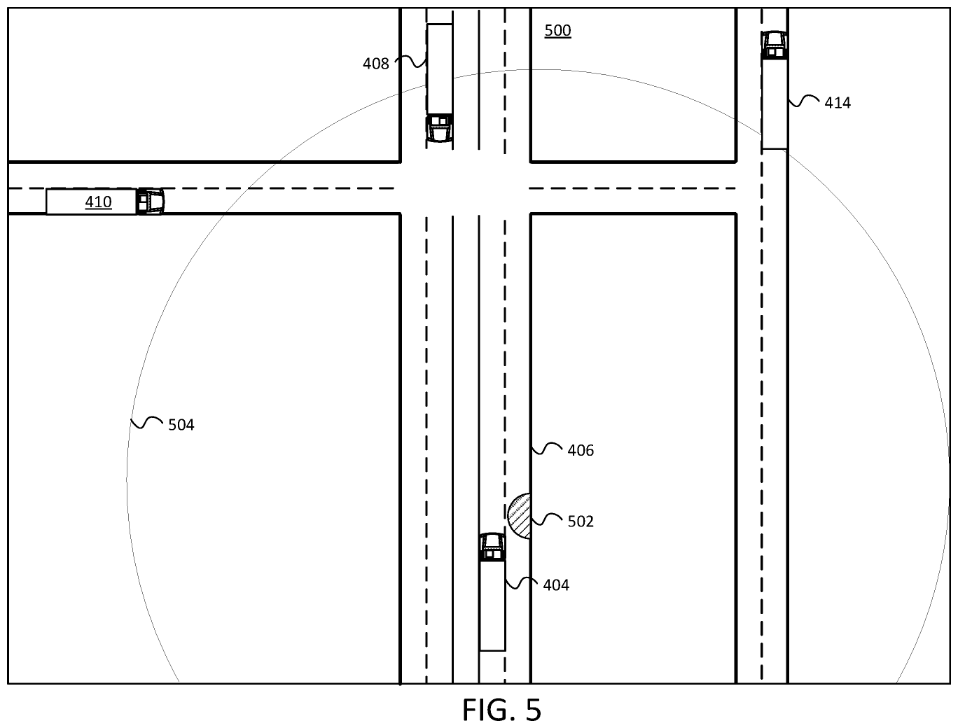

Referring to FIG. 5, yet another bird's-eye view 500 of a roadway, including a schematic representation of various vehicles is provided, according to an embodiment. For example, the bird's-eye view 500 of FIG. 5 can include a same set of roadways and vehicles as depicted in the bird's-eye view 400 of FIG. 4A. The depicted event 502 may be related to the event 402 of FIG. 4A. For example, the event 502 can be a same event 402/502 detected by further sensors 330 of the first autonomous vehicle 404, or, in various embodiments, the event 502 as captured by other autonomous vehicles 102. For example, the event 502 can be detected by the second autonomous vehicle 408 as the second autonomous vehicle 408 proceeds along the first roadway 406. The second autonomous vehicle 408 can provide an indication of the event 502 to the data processing system 302, whereupon the data processing system 302 can adjust the event 502 or an attribute thereof. For example, the different perspectives of the event received by the sensors 330 of the second autonomous vehicle 408 can be indicative of a different, class, confidence, type, or location of the event 402 of FIG. 4A. That is, the data processing system 302 can adjust the event or location on the digital map 322 responsive to an update for a same or different autonomous vehicle 102 subsequent to another update of the digital map 322.

Upon an update to the digital map 322, the data processing system 302 can determine one or more of the autonomous vehicles 102 to transmit the message to. For example, the data processing system 302 can receive an indication of a vehicle location via vehicle location data 326 received from the first 404, second 408, third 410, or fourth autonomous vehicle 414. As indicated above, the data processing system 302 can receive a heading, speed, route, or other information from the various autonomous vehicles 102. The data processing system 302 can define a centroid for a geographic region based on the vehicle location data 326 received from a vehicle providing the indication of the event (e.g., the first autonomous vehicle 404). For example, the centroid can be or be based on the vehicle location of the first autonomous vehicle 404, or the event 502 location.

The data processing system 302 can define a bounding line 504 around the centroid, such as the depicted radially defined bounding line 504. In various embodiments, the map apportioner 310 can define a bounding line 504 according to a grid square, municipality, travel time, or other indication. The map apportioner 310 can cause the transceiver 306 to transmit an updated digital map 322 based on the bounding line 504. For example, in the depicted embodiment, the map apportioner 310 can cause the transceiver 306 to transmit an updated digital map 322 to the first autonomous vehicle 404 based on the location thereof. The first autonomous vehicle 404 can perform a navigational action based on the receipt of the information. In some instances, such as where the first autonomous vehicle 404 has already performed a navigational action or traversed past the event 502, the first autonomous vehicle 404 can update a routine or instruction of the autonomy system 250 or the perception module 202 based on the receipt of the updated digital map 322. For example, the first autonomous vehicle 404 can retrain a machine learning model based on the update to the digital map 322, such as by employing a loss function between the updated digital map 322, and a local determination made at the first autonomous vehicle 404. In some embodiments, the map apportioner 310 can omit transmitting an updated digital map 322 to the first autonomous vehicle 404, wherein the detection of the event is responsive to a message received from the first autonomous vehicle 404.

The map apportioner 310 can cause the transceiver 306 to omit transmittal of an updated digital map 322 to the third autonomous vehicle 410 based on the location of the third autonomous vehicle 410 beyond the bounding line 504. The map apportioner 310 can cause the transceiver 306 to transmit an updated digital map 322 to the second autonomous vehicle 408 based on a combination of the heading of the vehicle (towards the event 502) and the location of the second autonomous vehicle 408 (within the bounding line 504). The map apportioner 310 can cause the transceiver 306 to omit transmittal of an updated digital map 322 to the fourth autonomous vehicle 414 based on a combination of the heading of the vehicle (away from the event 502) and the location of the second autonomous vehicle 408 (within the bounding line 504).

In some embodiments, the map apportioner 310 can define more than one bounding line 504. For example, for all vehicle within a first bounding line 504, the map apportioner 310 can cause the transceiver 306 to transmit an updated digital map 322. For vehicles within a second bounding line 504, the map apportioner 310 can cause the transceiver 306 to transmit an updated digital map 322 according to a direction, heading, or planned route of a vehicle. For vehicles beyond a second bounding line 504, the map apportioner 310 can cause the transceiver 306 to omit a transmittal of the updated digital map 322.

FIG. 6 is a flow diagram of an example method 600 of autonomous transport mapping, according to an embodiment. The method may be performed by one or more devices or elements of FIG. 1, 2, 3, or 7 such as an autonomous vehicle 102, the server 122, or another data processing system 302, including one or more processors. It is noted that the method 600 is merely an example and is not intended to limit the present disclosure. Accordingly, it is understood that additional operations may be provided before, during, and after the method 600 of FIG. 6, and that some other operations may only be briefly described herein.

In brief overview, the method 600 includes operation 602, maintaining a digital map 322 indicating locations of events based on messages containing indications of the locations of the events. The method 600 includes operation 604, receiving a first automatically generated message of the messages, from an autonomous vehicle 102 in response to a detection of an event. The method 600 includes operation 606, inserting the indication of the location associated with the autonomous vehicle 102 and the indication of the event into the digital map 322 to generate an updated digital map 322. The method 600 includes operation 608, transmitting the updated digital map 322 to another autonomous vehicle 102.

At operation 602, the method 600 includes maintaining a digital map 322 indicating locations of events based on messages containing indications of the locations of the events. The maintenance of the digital map 322 may refer to the storage, updating (e.g., adding, removing, or modifying events), or transmitting the updated digital maps 322 to various autonomous vehicles 102. The various messages can include automatically generated messages each containing an indication of a location of an event and/or an indication of the event itself (e.g., an event location or vehicle location of vehicle location data 326). At least a portion of the messages can be automatically generated messages from autonomous vehicles 102, as is further discussed with regard to operation 604, henceforth. In some embodiments, the method 600 can include receiving further messages indicative of weather data, road closures, hazardous conditions, or so forth. For example, the method 600 can include receiving various message types from various network connected devices to generate (e.g., update) digital maps 322.

At operation 604, the method 600 includes receiving a first automatically generated message of the messages from an autonomous vehicle 102. The data processing system 302 can receive the first automatically generated message in response to a detection of an event. The first autonomous vehicle 102 can detect the event or location based on data from sensors 330. For example, the perception module 116/202 can determine, classify, or otherwise indicate an event, or object indicative of an event, as is further described with regard to FIG. 1 or FIG. 2. For example, the autonomous vehicle 102 can detect an edge, movement, or reflectivity of one or more objects (e.g., one or more stationary vehicles involved in a collision). The sensors 330 of the autonomous vehicle 102 can further detect emergency vehicles according to colors, markings (e.g., employing character recognition), emergency lights (e.g., based on a color or movement), or so forth. The autonomous vehicle 102 can classify the event based on the plurality of detected objects. For example, the autonomous vehicle 102 can classify the event as a collision on the roadway, vehicles from a collision which have been relocated alongside a roadway, etc. The autonomous vehicle 102 can further include separate classifications for single vehicle accidents, multiple vehicle accidents, accidents with emergency vehicles present or absent, and the like.

The first autonomous vehicle 102 can include a first sensor (e.g., an imaging sensor) that generates and transmits data regarding the location of the event relative to the roadway, vehicle, or other relative reference to the autonomous vehicle 102. The first autonomous vehicle 102 can include a second sensor (e.g., a GNSS receiver 208) that generates data regarding a vehicle location (e.g., a current vehicle location) of the autonomous vehicle 102. The first autonomous vehicle 102 can determine the event location based on sensor data 324 from the first and second sensors, or can transmit sensor data 324 of the first and second sensors in the message. A computing device that receives the message, such as the data processing system 302, can determine an event location based upon the sensor data 324. In some embodiments, the automatically generated message can include sensor data 324 such as an image generated by a sensor or an indication of a sensor type employed to detect the event, including an orientation, image (or other detection data structure), model number, etc., such that other autonomous vehicles 102 can compare their sensor data 324 received from their own cameras to received sensors data, to determine similarities or dissimilarities between events For example, a difference in an object location or size captured by a same sensor type with a same orientation may be indicative of a change in object location. A difference in an object location or size captured by a different sensor type may be indicative of a property of an object, such as a paper bag which is absent in low frequency radar images, but present in visual spectrum imaging.

Although referring specifically to an automatically generated message received from a first autonomous vehicle 102, the data processing systems 302 described herein can be configured to receive automatically generated messages from various autonomous vehicles 102. For example, the messages can be received according to a predefined format which may include, for example, a vehicle identifier, sensor identifier, and imaging data, such that the information may be compared to other messages from various autonomous vehicles 102 having different vehicle identifiers, and sensor identifiers corresponding to the sensor identified in the indication of the event (e.g., a left facing LiDAR sensor of a particular version of a sensor suite). For example, the method 600 can further include receiving a second automatically generated message from a second autonomous vehicle 102, a third automatically generated message from a third autonomous vehicle 102, and so forth.

At operation 606, the method 600 includes inserting the indication of the location associated with the autonomous vehicle 102 and the indication of the event into the digital map 322 to generate an updated digital map 322. For example, the method 600 can include classifying the event according to a predetermined set of events, or determining a description for the event, or an indication of a response to the event. For example, the event can describe a collision which can be indicative of a response such as increasing caution (which may correspond to decreased speeds, increased following distances, and smaller step changes to vehicle controls); avoidance (which may correspond to lane guidance, re-pathing a route, etc.); or so forth. In some embodiments, method 600 may include providing an indication of a response (such as caution, avoidance, or the like) rather than or in addition to the indication of the classified event. For example, if multiple event types (e.g., wildlife in proximity to roadway or collision alongside roadway) are indicative of a same response (e.g., caution), the method can include inserting an indication of the response along with the event. In some embodiments, the method 600 can include inserting an indication of a gradation of an event or response thereto (e.g., severe, moderate, or mild).

In some embodiments, inserting the indication of the location or the indication of the event can depend on a confidence of the event or location. For example, the method 600 can include comparing a confidence for an event or location to a confidence threshold, and proceeding to operation 608 responsive to the confidence exceeding the confidence threshold. In some embodiments, the confidence can be based on messages received from various vehicles. For example, the confidence can be based on a combination of the messages received from the first and second vehicles. In some embodiments, the messages can each correspond to a same active event, or can correspond to non-active events, such as historical information indicative of a trend or likelihood of an event at a location. In some embodiments, the confidence may be based on a time elapsed from the detection of the event. For example, the time elapsed may correspond to a Boolean time-out, weighted aging wherein older indications are weighted lower than newer indications, or other techniques.

At operation 608, the method 600 includes transmitting the updated digital map 322 to another autonomous vehicle 102. According to various embodiments, the update can include a transmission of the updated digital map 322, or a portion thereof, to all vehicles in network communication a transceiver, or may be based on a vehicle location, type, identifier, message history, heading, or other information. For example, the method can include receiving a heading and location from an autonomous vehicle 102, determining whether one or more events of the digital map 322 is relevant to the autonomous vehicle 102 based on the heading, and transmitting or omitting the transmission based on the determination of the relevance. Thus, a throughput of information is decreased, while autonomous vehicles can receive relevant events.

The transmission can include a conveyance of a navigational action for the other autonomous vehicle 102, or the other autonomous vehicle 102 can locally determine a navigational action responsive to a receipt of the message. That is, the message can be configured to cause the other autonomous vehicle 102 to execute a navigational action. The message can further include sensor data 324 of the event, such that the other autonomous vehicle 102 can compare, react to, or otherwise process the sensor data 324. For example, the other autonomous vehicle 102 can determine a difference between the received sensor data 324 and detected information corresponding to the event and can provide updated information responsive to the message, whereupon the method 600 can further include updating the digital map 322 at the respective autonomous vehicle 102 based on the further information.

FIG. 7 is a block diagram illustrating an architecture for a computer system that can be employed to implement elements of the systems and methods described and illustrated herein, including, for example, the systems depicted in FIGS. 1, 2, and 3, and the method depicted in FIG. 6. The computing system 700 includes at least one bus 705 or other communication component for communicating information and at least one processor 710 or processing circuit coupled to the bus 705 for processing information. The computing system 700 can also include one or more processors 710 or processing circuits coupled to the bus for processing information. The computing system 700 also includes at least one main memory 715, such as a random access memory (RAM) or other dynamic storage device, coupled to the bus 705 for storing information, and instructions to be executed by the processor 710. The main memory 715 can be used for storing information during execution of instructions by the processor 710. The computing system 700 may further include at least one read only memory (ROM) 720 or other static storage device coupled to the bus 705 for storing static information and instructions for the processor 710. A storage device 725, such as a solid state device, magnetic disk or optical disk, can be coupled to the bus 705 to persistently store information and instructions.

The computing system 700 may be coupled via the bus 705 to a display 735, such as a liquid crystal display, or active matrix display, for displaying information to a user such as a driver of a vehicle or another end user. An input device 730, such as a keyboard or voice interface may be coupled to the bus 705 for communicating information and commands to the processor 710. The input device 730 can include a touch screen display 735. The input device 730 can also include a cursor control, such as a mouse, a trackball, or cursor direction keys, for communicating direction information and command selections to the processor 710 and for controlling cursor movement on the display 735.

The processes, systems and methods described herein can be implemented by the computing system 700 in response to the processor 710 executing an arrangement of instructions contained in main memory 715. Such instructions can be read into main memory 715 from another computer-readable medium, such as the storage device 725. Execution of the arrangement of instructions contained in main memory 715 causes the computing system 700 to perform the illustrative processes described herein. One or more processors in a multi-processing arrangement may also be employed to execute the instructions contained in main memory 715. Hard-wired circuitry can be used in place of or in combination with software instructions together with the systems and methods described herein. Systems and methods described herein are not limited to any specific combination of hardware circuitry and software.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code, it being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module, which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and Blu-ray disc, where “disks” usually reproduce data magnetically, while “discs” reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the embodiments described herein and variations thereof. Various modifications to these embodiments will be readily apparent to those skilled in the art, and the principles defined herein may be applied to other embodiments without departing from the spirit or scope of the subject matter disclosed herein. Thus, the present disclosure is not intended to be limited to the embodiments shown herein but is to be accorded the widest scope consistent with the following claims and the principles and novel features disclosed herein.

Various descriptions, herein, make use of the word “or” to refer to plurality alternative options. Such references are intended to convey an inclusive or. For example, various server 122 components herein can include hardware or software components. Such a disclosure indicates that the components may comprise a hardware component, a software component, or both a hardware and a software component.

While various aspects and embodiments have been disclosed, other aspects and embodiments are contemplated. The various aspects and embodiments disclosed are for purposes of illustration and are not intended to be limiting, with the true scope and spirit being indicated by the following claims.

What is claimed is:

1. A system comprising one or more processors, the one or more processors configured to:
maintain a digital map indicating locations of events based on a plurality of messages containing indications of the locations of the events;
receive a first automatically generated message of the plurality of messages, from a first autonomous vehicle in response to a detection of an event by the first autonomous vehicle, the first automatically generated message comprising:
an indication of a location associated with the first autonomous vehicle; and
an indication of the event;
insert the indication of the location associated with the first autonomous vehicle and the indication of the event into the digital map to generate an updated digital map; and
transmit the updated digital map to a second autonomous vehicle.

2. The system of claim 1, wherein the one or more processors are configured to convey an indication of a navigational action to the second autonomous vehicle responsive to the event.

3. The system of claim 1, wherein the one or more processors are configured to:
compare a confidence of the event to a confidence threshold;
receive an indication of a location associated with the second autonomous vehicle; and
transmit the updated digital map to the second autonomous vehicle based on the indication of the location associated with the second autonomous vehicle and responsive to the confidence of the event exceeding the confidence threshold.

4. The system of claim 3, wherein the confidence of the event is based on a second automatically generated message, generated by a third autonomous vehicle in response to an additional detection of the event.

5. The system of claim 3, wherein the one or more processors are configured to:
determine the confidence of the event based on a time elapsed from the detection of the event.

6. The system of claim 1, wherein the first automatically generated message comprises:
an indication of a sensor type employed to detect the event.

7. The system of claim 6, wherein the first automatically generated message comprises sensor data indicative of the event.

8. The system of claim 7, further comprising:
a third autonomous vehicle configured to:
detect the event, and generate local sensor data indicative of the event;
perform a navigational action responsive to the event; and
convey the indication of the event, the local sensor data, or the navigational action to the one or more processors.

9. The system of claim 8, wherein the third autonomous vehicle is further configured to:
receive sensor data indicative of the event from the one or more processors;
compare the received sensor data to the local sensor data; and
automatically transmit a second message to the one or more processors to provide a further indication of the event based on the comparison.

10. The system of claim 1, further comprising:
the first autonomous vehicle comprising:
a first sensor configured to detect a relative location of the event;
a second sensor configured to detect a vehicle location; and
one or more controllers configured to determine an event location based on the vehicle location and the relative location.

11. A method comprising:
maintaining, by one or more processors, a digital map indicating locations of events based on a plurality of messages containing indications of the locations of the events;
receiving, by the one or more processors, a first automatically generated message of the plurality of messages from a first autonomous vehicle in response to a detection of an event by the first autonomous vehicle, the first automatically generated message comprising:
an indication of a location associated with the first autonomous vehicle; and
an indication of the event;
inserting, by the one or more processors, the indication of the location associated with the first autonomous vehicle and the indication of the event into the digital map to generate an updated digital map; and
transmitting, by the one or more processors, the updated digital map to a second autonomous vehicle.

12. The method of claim 11, comprising:
conveying, by the one or more processors, an indication of a navigational action to the second autonomous vehicle responsive to the event.

13. The method of claim 11, comprising:
comparing, by the one or more processors, a confidence of the event to a confidence threshold;
receiving, by the one or more processors, an indication of a location associated with the second autonomous vehicle; and
transmitting, by the one or more processors, the updated digital map to the second autonomous vehicle based on the indication of the location associated with the second autonomous vehicle and responsive to the confidence of the event exceeding the confidence threshold.

14. The method of claim 11, wherein a confidence of the event is based on a second automatically generated message, generated by a third autonomous vehicle in response to an additional detection of the event.

15. The method of claim 11, further comprising:
determining, by the one or more processors, a confidence of the event based on a time elapsed from the detection of the event.

16. The method of claim 11, wherein the first automatically generated message comprises:
an indication of a sensor type employed to detect the event.

17. The method of claim 16, wherein the first automatically generated message comprises sensor data indicative of the event.

18. The method of claim 17, further comprising:
detecting, by a third autonomous vehicle, the event, and generate local sensor data indicative of the event;
performing, by the third autonomous vehicle, a navigational action responsive to the event; and
conveying, by the third autonomous vehicle, an indication of the local sensor data or the navigational action to the one or more processors.

19. The method of claim 18, further comprising:
receiving, by the third autonomous vehicle, sensor data indicative of the event from the one or more processors;
comparing, by the third autonomous vehicle, the received sensor data to the local sensor data; and
automatically transmitting, by the third autonomous vehicle, a second message to the one or more processors to provide a further indication of the event based on the comparison.

20. The method of claim 11, further comprising:
detecting, by a first sensor of the first autonomous vehicle, a relative location of the event;
detecting, by a second sensor of the first autonomous vehicle, a vehicle location; and
determining an event location based on the vehicle location and the relative location.
